(19) United States
(12) Patent Application Publication
(10) Pub. No.: US 2023/0080239 A1
(43) Pub. Date: Mar. 16, 2023

(54) COATING COMPOSITION FOR COMPOSITE POSITIVE ELECTRODE ACTIVE MATERIAL AND PREPARING METHOD OF COMPOSITE POSITIVE ELECTRODE ACTIVE MATERIAL USING THE SAME

(71) Applicants: Hyundai Motor Company, Seoul (KR); Kia Corporation, Seoul (KR); Kyonggi University Industry & Academia Cooperation, Suwon (KR)

(72) Inventors: Sung Woo Noh, Seoul (KR); Sang Heon Lee, Yongin (KR); Je Sik Park, Seoul (KR); Jung Hyun Seo, Daejeon (KR); Im Sul Seo, Chungcheongbuk-do (KR); Ju Young Seong, Suwon (KR); Chung Bum Lim, Suwon (KR); Yong Joon Park, Seoul (KR); Jun Su Lee, Seoul (KR); Da Hye Yoon, Suwon (KR); Joo Young Lee, Suwon (KR)

(21) Appl. No.: 17/943,795

(22) Filed: Sep. 13, 2022

(30) Foreign Application Priority Data
Sep. 14, 2021 (KR) 10-2021-0122210

(51) Int. Cl. H01M 4/36; H01M 4/58

(52) U.S. Cl. CPC H01M 4/366; H01M 4/5825; H01M 2004/028

(57) ABSTRACT

Disclosed are a coating composition for a composite positive electrode active material and a method of preparing a composite positive electrode active material using the same.

### CROSS-REFERENCE TO RELATED APPLICATION

This application claims under 35 U.S.C. § 119(a) the benefit of priority to Korean Patent Application No. 10-2021-0122210 filed on Sep. 14, 2021, the entire contents of which are incorporated herein by reference.

### TECHNICAL FIELD

The present invention relates to a coating composition for a composite positive electrode active material and a method of preparing a composite positive electrode active material using the same.

### BACKGROUND

In an all-solid-state secondary battery using a sulfide-based solid electrolyte, cell properties may be degraded due to an interfacial reaction between the sulfide-based solid electrolyte and a positive electrode active material including an oxide-based compound.

Therefore, in order to solve this problem, for example, a stable material is coated on a surface of the positive electrode active material. Although the surface of the positive electrode active material is also coated in a lithium-ion battery, the method or purpose is completely different from that of an all-solid-state secondary battery, and thus, there is also a difference in the material and the thickness used. The coating material for the positive electrode active material of the lithium-ion battery may be used for preventing a reaction with an organic liquid electrolyte such as hydrofluoric acid (HF), and for example, mainly alumina (Al₂O₃), zirconia (ZrO₂), etc., has been used as the coating material.

The coating material for the positive electrode active material for an all-solid-state secondary battery should be stable when in contact with a sulfide-based solid electrolyte. In addition, a liquid electrolyte permeates a positive electrode, such that lithium-ion conductivity is not important for a coating material for a lithium-ion battery. However, when a solid electrolyte is used, the path of ion conduction between a solid and a solid needs to be connected, and thus, a coating material also needs to have an excellent lithium-ion conductivity. In addition, when the coating layer is thickly formed in an all-solid-state secondary battery, it is important to form a thin and uniform coating layer because the resistance in the electrode rapidly increases. In lithium-ion batteries, even if the coating layer is slightly thick or non-uniform, a liquid electrolyte permeates the electrode, so it is not a serious problem.

In the related art, LiNbO₃ is known as a coating material that satisfies the above conditions, but it is a very expensive material and is a major obstacle in mass production.

Accordingly, Li₃PO₄ may be used as a coating material for a composite positive electrode active material for an all-solid-state secondary battery. The coating layer including Li₃PO₄ formed on the surface of the positive electrode active material may stabilize the interface of the positive electrode active material, which becomes thermodynamically and electrochemically unstable when in contact with a sulfide-based solid electrolyte. In addition, the coating layer may improve electrochemical properties of the all-solid-state secondary battery using the sulfide-based solid electrolyte by alleviating the formation of an unnecessary interfacial layer formed by side reactions.

However, experiments show that the performance Li₃PO₄ as a coating material has still not been sufficient for use. For example, it is difficult to uniformly form a coating layer including Li₃PO₄. As a phosphorus source material for forming the coating layer, containing Li₃PO₄, NH₄H₂PO₄ or (NH₄)₂HPO₄, etc. are mainly used, but since they are not soluble in organic solvents, an aqueous solvent needs to be used. However, when an aqueous solvent is used, the coating material is not uniformly attached to the surface because the wettability of the surface of the positive electrode active material made of oxide is poor. In addition, since the positive electrode active material with a high nickel (Ni) content is vulnerable to moisture, the properties deteriorate after coating. Thus, Li₃PO₄ has not been applied to the all-solid-state secondary battery because it was difficult to use in practice.

### SUMMARY

In preferred aspects, provided are a coating composition and a method of preparing uniformly forming a coating layer including Li₃PO₄ on the surface of a positive electrode active material.

An object of the present invention is not limited to the above-mentioned objects. An object of the present invention will become more apparent from the following description, and will be implemented by the means described in the claims and a combination thereof.

In an aspect, provided is a coating composition for a composite positive electrode active material that may include: a lithium component; a phosphorus component containing polyphosphoric acid; and an organic solvent dissolving the phosphorus component. The term “lithium component” as used herein refers to a compound (e.g., covalent compound, ionic compound, or salt) including one or more lithium atoms in its molecular formula. Preferred lithium components may include ionic compound or salt form thereof (e.g., lithium ethoxide, Li₂CoO₃, and LiOH), which can dissociate into cation and anion in a polar solvent (e.g., aqueous solution, alcohol or polar aprotic solvent).

The term “phosphorus component” as used herein refers to a compound (e.g., covalent compound, ionic compound, or salt) including one or more phosphorous atoms in its molecular formula. Preferred phosphorus components may include a acid or base compound (e.g., polyphosphoric acid), which can produce or dissociate to produce acid or base in a polar solvent (e.g., aqueous solution, alcohol or polar aprotic solvent).

Preferably, the phosphorus component may include polyphosphoric acid.

The lithium component may suitably include one or more selected from the group consisting of lithium ethoxide, Li₂CoO₃, and LiOH.

The organic solvent may suitably include one or more selected from the group consisting of an alcohol, a carbonate-based solvent, an ether-based solvent, and dimethyl sulfoxide (DMSO).

In an aspect, provided is a method of preparing a composite positive electrode active material may include: preparing a coating composition by dissolving a lithium component and a phosphorus component including polyphosphoric acid in an organic solvent; forming an admixture by adding a positive electrode active material to the coating composition and stirring; and heat treating the admixture to form the composite positive electrode active material. Particularly, a coating layer including the coating composition is formed on the surface of the positive electrode active material.

Preferably, the phosphorus component may include polyphosphoric acid. The positive electrode active material may suitably include Liₐ[NiₓCo_{y}Mn_{z}M_{1-x-y-z}]O₂ (wherein, 1.0≤a≤1.2, 0.0≤x<1.0, 0.1≤y≤1.0, 0.0≤z≤1.0, 0.0≤-x-y-z≤0.3).

The stirring may be performed at a temperature of about −10° C. to +10° C. of the boiling point of the organic solvent.

The preparing method may further include drying the admixture before heat treating the admixture.

The heat treating may be performed on the admixture at a temperature of about 300° C. to 500° C. in an oxygen atmosphere.

The coating layer may suitably include Li₃PO₄. The coating layer may have a thickness of about 0.5 nm to 50 nm. The coating layer may have a thickness of about 1 nm to 2 nm. The composite positive electrode active material may suitably include the coating layer in an amount of about 0.01 wt % to 10 wt % based on the total weight of the composite positive electrode active material.

The composite positive electrode active material may suitably include the coating layer in an amount of about 0.01 wt % to 0.05 wt % based on the total weight of the composite positive electrode active material.

Also provided is an all-solid-state secondary battery including the composite positive electrode active material as described herein. For example, the composited positive electrode active material may be prepared by the method described herein.

Other aspects of the invention are disclosed infra.

### BRIEF DESCRIPTION OF THE DRAWINGS

FIG. 1 an exemplary composite positive electrode active material according to an exemplary embodiment of the present invention.

FIG. 2 shows a result of analyzing a positive electrode active material in Comparative Example 1 with a transmission electron microscope.

FIGS. 3A to 3C show results of analyzing a composite positive electrode active material in Comparative Example 2 at different sites.

FIGS. 4A to 4C show results of analyzing a composite positive electrode active material in the Example at different sites according to an exemplary embodiment of the present invention.

FIG. 5A shows a result of analyzing the positive electrode active material in Comparative Example 1 with a scanning electron microscope.

FIG. 5B shows a result of analyzing a composite positive electrode active material in Comparative Example 2 with a scanning electron microscope.

FIG. 5C shows a result of analyzing a composite positive electrode active material in the Example with a scanning electron microscope according to an exemplary embodiment of the present invention.

FIG. 6 shows a result of measuring the discharge capacity of positive electrodes including the composite positive electrode active materials in the Example according to an exemplary embodiment of the present invention and Comparative Examples 1 and 2 depending on various current densities.

FIG. 7 shows a first charge/discharge curve of positive electrodes including composite positive electrode active materials in the Example according to an exemplary embodiment of the present invention and Comparative Examples 1 and 2.

FIG. 8 shows a result of measuring impedance characteristics of positive electrodes including composite positive electrode active materials in the Example according to an exemplary embodiment of the present invention and Comparative Examples 1 and 2.

### DETAILED DESCRIPTION

The above objects, other objects, features, and advantages of the present invention will be easily understood through the following preferred embodiments related to the accompanying drawings. The present invention, however, is not limited to exemplary embodiments described herein and may also be embodied in other forms. On the contrary, exemplary embodiments introduced herein are provided to make disclosed contents thorough and complete and sufficiently transfer the spirit of the present invention to those skilled in the art.

Similar reference numerals have been used for similar elements in describing each drawing. In the accompanying drawings, dimensions of structures may be enlarged as compared with actual dimensions for clarity of the present invention. The terms first, second, etc. may be used to describe various components, but the components are not to be interpreted to be limited to the terms. The terms are used only to distinguish one component from another component. For example, a first component may be referred to as a second component and the second component may also be similarly referred to as the first component, without departing from the scope of the present invention. Singular forms are intended to include plural forms unless the context clearly indicates otherwise.

It should be understood that term “comprise” or “have”, etc., as used herein, specify the presence of features, numerals, steps, operations, components, parts described herein, or combinations thereof, but do not preclude the presence or addition of one or more other features, numerals, steps, operations, components, parts, or combinations thereof. It will be understood that when an element such as a layer, a film, a region, or a substrate, is referred to as being “on” another element, it may be “directly on” another element or may have an intervening element present therebetween. In contrast, it will be understood that when an element such as a layer, a film, a region, or a substrate is referred to as being “under” another element, it can be “directly under” the other element or intervening elements may also be present.

It should be understood that unless otherwise specified, all numbers, values and/or expressions expressing ingredients, reaction conditions, polymer compositions, and quantities of formulations used herein, are approximations essentially reflecting various uncertainties of the measurement that these numbers result from obtaining these values, among other things, and are therefore modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are invention herein, such ranges are continuous and include all values from a minimum value to a maximum value inclusive of the maximum value of such ranges, unless otherwise indicated. Furthermore, when such ranges refer to an integer, all integers from the minimum value to the maximum value inclusive of the maximum value are included, unless otherwise indicated.

In the present specification, when a range is described for a variable, it will be understood that the variable includes all values including the end points described within the stated range.

For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

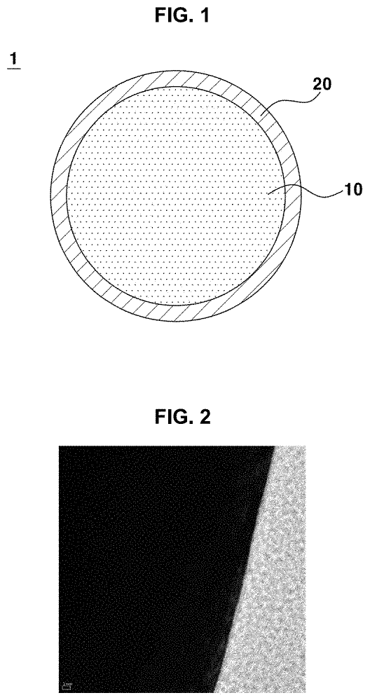

FIG. 1 shows a cross-sectional view illustrating a composite positive electrode active material according to the present invention. As shown in FIG. 1, the composite positive electrode active material 1 may include a core 10 and a coating layer 20 coated on the surface of the core 10.

The core 10 may include a positive electrode active material. The positive electrode active material may suitably include any material that is widely used in the art to which the present invention pertains, for example, Liₐ[NiₓCo_{y}Mn_{z}M_{1-x-y-z}]O₂ (wherein 1.0≤a≤1.2, 0.0≤x<1.0, 0.1≤y≤1.0, 0.0≤z≤1.0, 0.0≤1-x-y-z≤0.3).

The coating layer 20 may suitably include Li₃PO₄.

The Li₃PO₄ is chemically very stable because the non-metal, elemental phosphorus (P) and oxygen (O) form a strong covalent bond due to orbital hybridization. Meanwhile, a process in which anions are exchanged between a phosphate-based oxide and a sulfide solid electrolyte and a reactant is formed easily occurs because the exchange reaction is thermodynamically stable. Since Li₃PO₄ contains the same anion as the phosphate-based oxide and P₅⁺, which is the same cation as the sulfide-based solid electrolyte, a thermodynamic driving force toward the exchange reaction does not occur as a compound in an intermediate position between them. For this reason, the coating layer 20 including Li₃PO₄ is stable to both oxide and sulfide, and thus may effectively suppress a side reaction between the positive electrode active material and the sulfide-based solid electrolyte.

The coating layer 20 may have a thickness of about 0.5 nm to 50 nm, preferably 1 nm to 2 nm. When the thickness of the coating layer 20 is less than about 0.5 nm, it may not be possible to prevent contact between the positive electrode active material and the sulfide-based solid electrolyte. When the thickness of the coating layer 20 is greater than about 50 nm, the resistance in the electrode may be increased.

The coating layer 20 may be included in an amount of about 0.01 wt % to 10 wt %, preferably 0.01 wt % to 0.05 wt % of the total weight of the composite positive electrode active material 1. When the content of the coating layer 20 is less than about 0.01 wt %, it may not be possible to prevent contact between the positive electrode active material and the sulfide-based solid electrolyte. When the content of the coating layer 20 is greater than about 10 wt %, the resistance in the electrode may be increased.

Hereinafter, a method of preparing the composite positive electrode active material 1 will be described in detail.

The method may include: preparing a coating composition by dissolving a lithium component and a phosphorus component in an organic solvent, forming an admixture by adding a positive electrode active material to the coating composition and performing stirring, and heat treating the admixture to form the composite positive electrode active material.

The lithium component is not particularly limited, but may contain, for example, one or more selected from the group consisting of lithium ethoxide, Li₂CoO₃, LiOH, and combinations thereof. The phosphorus component may preferably include polyphosphoric acid.

In particular, an organic solvent may be used as a solvent of the coating composition, and polyphosphoric acid dissolved in the organic solvent is used as the phosphorus component.

Conventionally, a phosphorus component such as NH₄H₂PO₄ or (NH₄)₂HPO₄ was used when a coating layer including Li₃PO₄ is formed in a lithium-ion battery. Since these are dissolved in an aqueous solvent, a coating composition was prepared using distilled water as a solvent. However, when the aqueous solvent is used, the coating layer is not uniformly formed because the wettability of the surface of the positive electrode active material containing the oxide is poor. In addition, since the positive electrode active material containing nickel (Ni) is vulnerable to moisture, as in the present invention, properties deteriorate in the process of forming the coating layer.

The organic solvent-based coating composition according to the present invention may be evenly spread on the surface of the positive electrode active material, thereby obtaining a uniform coating layer.

The type of the organic solvent is not particularly limited, but may include one or more selected from the group consisting of an alcohol-based solvent, a carbonate-based solvent, an ether-based solvent, and dimethyl sulfoxide (DMSO).

The amounts to be added of the lithium component and the phosphorus component are not particularly limited, and the lithium component and the phosphorus component were added in stoichiometric amounts so that the content of the coating layer 20 caused by the lithium component and the phosphorus component may range from about 0.01 wt % to 10 wt % as described above.

In addition, the content of the organic solvent may be appropriately adjusted according to the amount of the positive electrode active material to be described later. For example, about 5 ml to 50 ml of the organic solvent may be used per gram (g) of the positive electrode active material.

Thereafter, the positive electrode active material may be added to the coating composition and the admixture may be stirred.

The conditions of the stirring are not particularly limited, but may be performed at a temperature of about −10° C. to +10° C. of the boiling point of the organic solvent for about 1 hour to 10 hours.

A step of removing the organic solvent as much as possible by stirring and drying the remaining organic solvent to completely remove the remaining organic solvent may be further performed.

The dried admixture may be heat treated at about 300° C. to 500° C. in an oxygen atmosphere for about 1 hour to 10 hours to induce a reaction between the lithium component and the phosphorus component evenly adhered to the surface of the positive electrode active material.

Hereinafter, another embodiment of the present invention will be described in more detail through Examples. The following Examples are only examples to assist the understanding of the present invention, and the scope of the present invention is not limited thereto.

### EXAMPLE

A coating composition was prepared by using lithium ethoxide as a lithium component and polyphosphoric acid as a phosphorus component, and adding and dissolving the lithium ethoxide and the polyphosphoric acid in ethanol as an organic solvent. The lithium component and the phosphorus component were added in stoichiometric amounts so that the content of a coating layer of the finally obtained composite positive electrode active material was 0.03 wt %. In addition, 30 ml of the organic solvent was used.

About 5 g of the positive electrode active material was added to the coating composition. As the positive electrode active material, a compound represented by Li[Ni_{0.75}Co_{0.1}Mn_{0.15}]O₂ was used. The coating composition to which the positive electrode active material was added was stirred at a temperature of about 70° C. for about 4 hours. Then, the organic solvent was completely removed by drying the coating composition in a vacuum oven at a temperature of about 90° C. for about 2 hours.

The admixture was heat-treated in an oxygen atmosphere at a temperature of about 400° C. for about 1 hour to complete a composite positive electrode active material.

### Comparative Example 1

A positive electrode active material in which a coating layer was not formed was set as Comparative Example 1. The positive electrode active material is Li[Ni_{0.75}Co_{0.1}Mn_{0.15}]O₂.

### Comparative Example 2

A composite positive electrode active material was prepared under the same conditions and methods as in Example 1, except that NH₄H₂PO₄ was used as the phosphorus component and distilled water was used as the solvent as in the prior art.

### Experimental Example 1

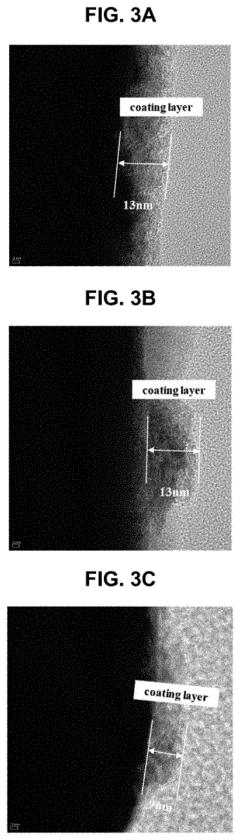

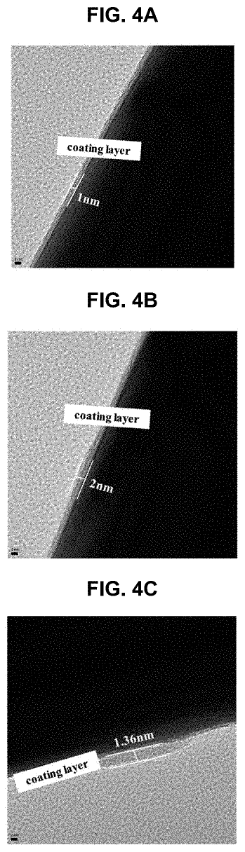

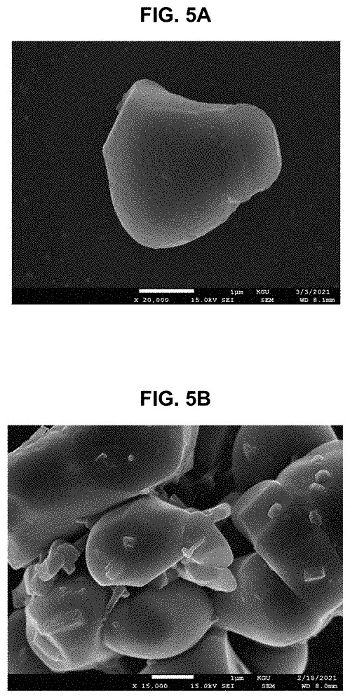

The admixture according to the Example, Comparative Example 1, and Comparative Example 2 were analyzed with a transmission electron microscope (TEM). FIG. 2 shows the result of Comparative Example 1, FIGS. 3A to 3C are the results of analyzing the admixture of Comparative Example 2 at different sites, and FIGS. 4A to 4C are the results of analyzing the admixture of the Example at different sites.

As shown in FIGS. 3A to 3C, in the composite positive electrode active material in Comparative Example 2, the coating layer had a thickness of about 9 nm to 13 nm, and in particular, the coating layer was non-uniformly formed as shown in FIGS. 3B and 3C. On the other hand, as shown in FIGS. 4A to 4C, in the composite positive electrode active material in the Example according to an exemplary embodiment, the coating layer was formed very evenly with a thickness of about 1 nm to 2 nm.

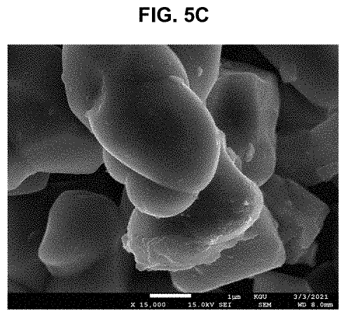

The results according to the Example, Comparative Example 1, and Comparative Example 2 were analyzed with a scanning electron microscope (SEM). FIGS. 5A to 5C show results of Comparative Example 1, Comparative Example 2, and Example, respectively. As shown in FIG. 5B, a large numbery of large foreign particles were formed in the composite positive electrode active material according to Comparative Example 2. On the other hand, as shown in FIG. 5C, since the composite positive electrode active material in the Example had relatively few foreign particles, most of the lithium component and the phosphorus component were used for the coating layer.

### Experimental Example 2

Positive electrodes including composite positive electrode active materials in the Example, and Comparative Examples 1 and 2 were prepared, and electrochemical properties thereof were compared.

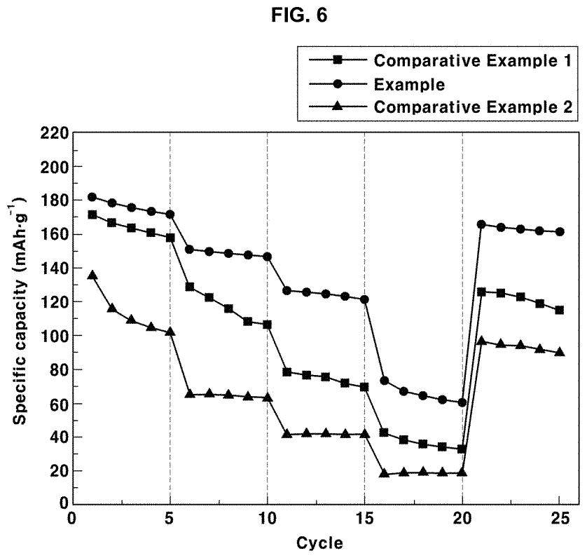

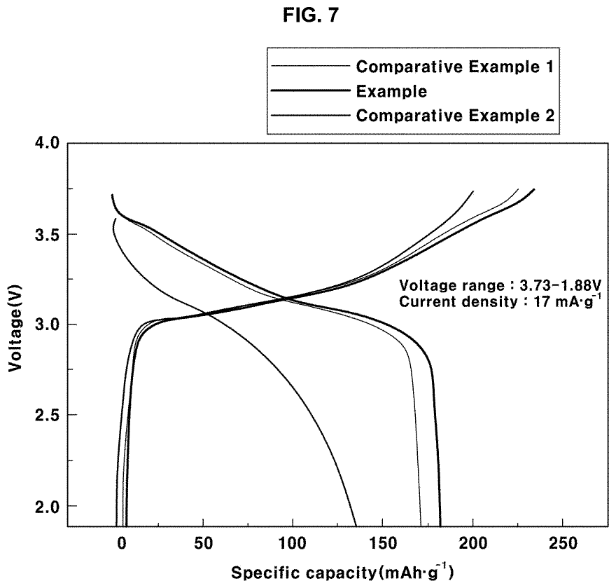

FIG. 6 shows a result of measuring the discharge capacity of a positive electrode including the composite positive electrode active material according to Example, and Comparative Examples 1 and 2 depending on various current densities. The results were specifically shown in Table 1. FIG. 7 shows a first charge/discharge curve of a positive electrode including a composite positive electrode active material in the Example according to an exemplary embodiment of the present invention and Comparative Examples 1 and 2.

TABLE 1

| | Comparative Example 1 | | Comparative Example 2 | | Example | |
|---|---|---|---|---|---|---|
| | | Capacity | | Capacity | | Capacity |
| | Discharge | retention | Discharge | retention | Discharge | retention |
| Current | capacity | rate | capacity | rate | capacity | rate |
| density | [mAh/g] | [%] | [mAh/g] | [%] | [mAh/g] | [%] |
| 17 mAh/g | 171.6 | 100 | 135.6 | 100 | 182 | 100 |
| | | (η = 76.5) | | (η = 68.4) | | (η = 78.3) |
| 34 mAh/g | 128.7 | 75 | 65 | 48 | 150.8 | 82.9 |
| | | (η = 89.4) | | (η = 84.9) | | (η = 95.4) |
| 51 mAh/g | 78.4 | 45.6 | 41.5 | 30.6 | 126.6 | 69.57 |
| | | (η = 79) | | (η = 87) | | (η = 94.6) |

In Table 1, η means coulombic efficiency.

The Example showed excellent discharge capacity at all measured current densities compared to Comparative Examples 1 and 2, and high-rate capability was improved in view of maintaining high discharge capacity even under the conditions of high current density.

In particular, Comparative Example 2 shows rather inferior discharge capacity compared to Comparative Example 1, but in Comparative Example 2, considering that the content and compound of the coating layer are the same as in the Example, since the coating layer was not sufficiently uniformly formed, it did not serve as a protective film, and the deterioration of the positive electrode active material had occurred due to the use of an aqueous solvent.

### Experimental Example 3

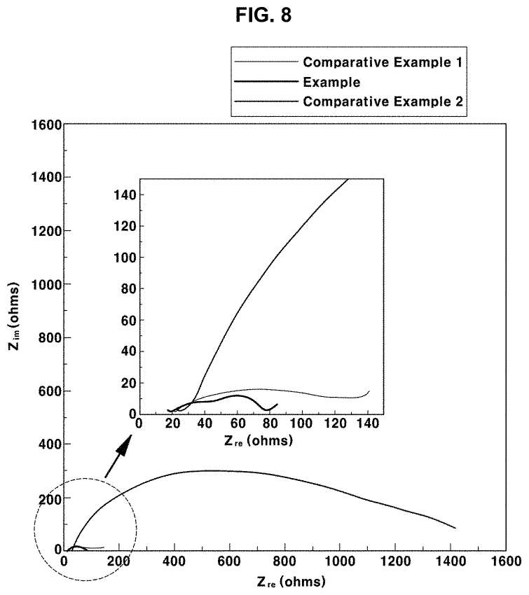

Positive electrodes including composite positive electrode active materials in the Example and Comparative Examples 1 and 2 were prepared, and impedance properties thereof were measured. The results are shown in FIG. 8.

As the impedance properties, the resistance component at the interface during cell manufacturing may be compared. In general, when the size of the semicircles in the Nyquist plot is large, the impedance resistance component may be large.

In Comparative Example 2, a very large impedance value was observed compared to Comparative Example 1 and the Example. Such a high impedance resistance component showed that the positive electrode active material was subject to a serious damage in the process of coating the surface of the positive electrode active material. The case of the serious damage may first consider an interfacial reaction between moisture and a positive electrode active material containing nickel element due to the use of an aqueous solvent. In addition, the possibility that the resistance component had increased due to the non-uniform coating layer cannot be excluded.

On the other hand, the Example showed lower impedance than Comparative Example 1, which may be resulted from the increase in interfacial stability through the formation of a uniform coating layer, and thus the resistance component is reduced.

In addition, the reduction in impedance of the Example may be in connection with the excellent discharge capacity and high-rate capability of the Example observed in FIGS. 6 and 7. The low interfacial resistance obtained by the effect of the coated layer resulted in an increase in capacity and an improvement in rate-limiting properties.

According to various exemplary embodiments of the present invention, the coating layer including Li₃PO₄ may be uniformly formed on a surface of the positive electrode active material.

According to various exemplary embodiments of the present invention, an all-solid-state secondary battery having a high capacity and an excellent high-rate capability may be obtained when the composite positive electrode active material according to the present invention is used.

The effects of the present invention are not limited to the above-mentioned effects. It should be understood that the effects of the present invention include all effects that can be inferred from the following descriptions.

Although the Experimental Examples and Example of the present invention have been described in detail hereinabove, the scope of the present invention is not limited thereto, but may include several modifications and alterations made by those skilled in the art using a basic concept of the present invention as defined in the claims.

What is claimed is:

1. A coating composition for a composite positive electrode active material, comprising:
a lithium component;
a phosphorus component; and
an organic solvent dissolving the phosphorus component.

2. The coating composition of claim 1, wherein the phosphorus component comprises polyphosphoric acid.

3. The coating composition of claim 1, wherein the lithium component comprises one or more selected from the group consisting of lithium ethoxide, Li₂CoO₃, and LiOH.

4. The coating composition of claim 1, wherein the organic solvent includes one or more selected from the group consisting of an alcohol, a carbonate-based solvent, an ether-based solvent, and dimethyl sulfoxide.

5. A method of preparing a composite positive electrode active material, comprising:
preparing a coating composition by dissolving a lithium component and a phosphorus component in an organic solvent; forming an admixture by adding a positive electrode active material to the coating composition and performing stirring; and
heat treating the admixture to form the composite positive electrode active material comprising a core and a coating layer coated on the surface of the core,
wherein a core comprises the positive electrode active material, and
a coating layer including the coating composition is formed on the surface of the positive electrode active material.

6. The method of claim 5, wherein the phosphorus component comprises polyphosphoric acid.

7. The method of claim 5, wherein the lithium component comprises one or more selected from the group consisting of lithium ethoxide, Li₂CoO₃, and LiOH.

8. The method of claim 5, wherein the organic solvent comprises one or more selected from the group consisting of an alcohol, a carbonate-based solvent, an ether-based solvent, and dimethyl sulfoxide.

9. The method of claim 5, wherein the positive electrode active material comprises Liₐ[NiₓCo_{y}Mn_{z}M_{1-x-y-z}]O₂ (wherein, 1.0≤a≤1.2, 0.0≤x≤1.0, 0.1≤y≤1.0, 0.0≤z≤1.0, 0.0≤1-x-y-z≤0 .3).

10. The method of claim 5, wherein the stirring is performed at a temperature of about −10° C. to +10° C. of the boiling point of the organic solvent.

11. The method of claim 5, further comprising drying the admixture before heat treating the admixture.

12. The method of claim 5, wherein the heat treating the admixture is performed at a temperature of about 300° C. to 500° C. in an oxygen atmosphere.

13. The method of claim 5, wherein the coating layer comprises Li₃PO₄.

14. The method of claim 5, wherein the coating layer has a thickness of about 0.5 nm to 50 nm.

15. The method of claim 5, wherein the coating layer has a thickness of about 1 nm to 2 nm.

16. The method of claim 5, wherein the composite positive electrode active material comprises the coating layer in an amount of about 0.01 wt % to 10 wt % based on the total weight of the composite positive electrode active material.

17. The method of claim 5, wherein the composite positive electrode active material comprises the coating layer in an amount of about 0.01 wt % to 0.05 wt % based on the total weight of the composite positive electrode active material.

18. An all-solid-state secondary battery comprising a composite positive electrode active material prepared by a method of claim 5.
